(19) United States
(12) Patent Application Publication
(10) Pub. No.: US 2026/0097816 A1
(43) Pub. Date: Apr. 9, 2026

(54) AIR TANK ISOLATOR SYSTEM

(71) Applicant: Hyundai Translead, San Diego, CA (US)

(72) Inventor: Joel Maldonado Contreras, Tijuana (MX)

(21) Appl. No.: 19/344,266

(22) Filed: Sep. 29, 2025

Related U.S. Application Data
(60) Provisional application No. 63/703,107, filed on Oct. 3, 2024.

(51) Int. Cl. B62D 27/04; F16F 15/08

(52) U.S. Cl. CPC B62D 27/04; F16F 15/08; F16F 2226/04

(57) ABSTRACT

A system for dampening forces between a suspension frame and an air tank is provided. In one aspect, the system includes a first resilient isolator pad positioned between a first side of an attachment bracket of the air tank and a support rail of the suspension frame. The system also includes a second resilient isolator pad positioned on a second side of the attachment bracket; a retention plate positioned on a side of the second resilient isolator pad opposite the attachment bracket; and one or more fasteners extending through the retention plate, the second resilient isolator pad, the first resilient isolator pad, and the support rail.

### CROSS-REFERENCE TO RELATED APPLICATIONS

This application claims priority to U.S. Provisional Patent Application No. 63/703,107 filed on October 3, 2024, and entitled “AIR TANK ISOLATOR SYSTEM.” Each application referenced in this paragraph is hereby incorporated by reference herein in its entirety.

### BACKGROUND

### Field

The present technology relates to a system for isolating an air tank attached to a suspension frame on a trailer, truck, or other vehicle.

### Description of the Related Art

The braking systems on trucks and trailers often use air tanks to supply air pressure to brake lines. These air tanks can have thin walls and often include attachment brackets welded on each end for mounting the air tank on to a suspension frame between the wheels of the truck or trailer. Vibrational and impact forces can pass from the suspension frame into the attachment brackets. This force transfer can cause the welds between the attachment bracket and the air tank to fatigue and crack the thin-walled air tank. Therefore, a need exists for a system for dampening and/or isolating the forces from the suspension frame transferred into attachment brackets of air tanks.

### SUMMARY

For purposes of summarizing the present disclosure and its advantages, certain objects and advantages of the present disclosure are described herein. Not all such objects or advantages may be achieved in any particular embodiment of the present disclosure. Thus, for example, those skilled in the art will recognize that the present disclosure may be embodied or carried out in a manner that achieves or optimizes one advantage or group of advantages as taught herein without necessarily achieving other objects or advantages as may be taught or suggested herein.

In one aspect, a system for dampening forces between a suspension frame and an air tank is provided. The system includes a first resilient isolator pad positioned between a first side of an attachment bracket of the air tank and a support rail of the suspension frame, a second resilient isolator pad positioned on a second side of the attachment bracket, a retention plate positioned on a side of the second resilient isolator pad opposite the attachment bracket, and one or more fasteners extending through the retention plate, the second resilient isolator pad, the first resilient isolator pad, and the support rail.

In some embodiments, the first side of the attachment bracket is a bottom side of the attachment bracket.

In some embodiments, the second side of the attachment bracket is a top side of the attachment bracket.

In some embodiments, the retention plate is positioned on a top side of the second resilient isolator pad.

In some embodiments, the retention plate is in direct physical contact with the side of the second resilient isolator pad.

In some embodiments, the first resilient isolator pad is in direct physical contact with the first side of the attachment bracket.

In some embodiments, the first resilient isolator pad is in direct physical contact with the support rail.

In some embodiments, the second resilient isolator pad is in direct physical contact with the second side of the attachment bracket.

In some embodiments, the one or more fasteners include one or more threaded bolts engaged with one or more lock nuts.

In some embodiments, a head of each of the one or more threaded bolts is in direct physical contact with the retention plate.

In some embodiments, the first resilient isolator pad has a thickness T1 in a height direction that is greater than a thickness T2 of the second resilient isolator pad.

In some embodiments, the first resilient isolator pad has a thickness T1 in the height direction that is twice a thickness T2 of the second resilient isolator pad.

In some embodiments, at least one of the first resilient isolator pad and the second resilient isolator pad include neoprene.

In some embodiments, the first resilient isolator pad has a thickness T1 of 1/2" and the second resilient isolator pad has a thickness T2 of 1/4".

In another aspect, a method of assembling an air tank on a suspension frame is provided. The method includes positioning a first resilient isolator pad on top of a support rail of the suspension frame, positioning the air tank including an attachment bracket over the first resilient isolator pad such that the first resilient isolator pad is between the support rail and a first side of the attachment bracket, positioning a second resilient isolator pad and a retention plate on a second side of the attachment bracket, passing one or more fasteners through the retention plate, the second resilient isolator pad, the first resilient isolator pad, and the support rail, and fastening each of the one or more fasteners to a torque.

In some embodiments, the method further includes positioning a third resilient isolator pad on top of a second support rail of the suspension frame, positioning a second attachment bracket of the air tank over the third resilient isolator pad such that the third resilient isolator pad is between the second support rail and a first side of the second attachment bracket, positioning a fourth resilient isolator pad and a second retention plate on a second side of the second attachment bracket, passing one or more fasteners through the second retention plate, the fourth resilient isolator pad, the third resilient isolator pad, and the second support rail, and fastening each of the one or more fasteners to a torque.

In some embodiments, the retention plate is in direct physical contact with the second resilient isolator pad.

In some embodiments, the torque includes a torque between 14 and 16 lb-ft.

In some embodiments, a thickness T1 of the first resilient isolator pad in a height direction is twice a thickness T2 of the second resilient isolator pad.

In some embodiments, the one or more fasteners include one or more threaded bolts, and a head of each of the one or more threaded bolts is in direct physical contact with the retention plate.

### BRIEF DESCRIPTION OF THE DRAWINGS

The above-mentioned aspects, as well as other features, aspects, and advantages of the present technology will now be described in connection with various embodiments, with reference to the accompanying drawings. The illustrated embodiments, however, are merely examples and are not intended to be limiting. Like reference numbers and designations in the various drawings indicate like elements.

FIG. 1 illustrates a view of an embodiment an air tank attached to a suspension frame.

FIG. 2 illustrates a view of an embodiment of a system for isolating forces between an air tank and a support rail according to an embodiment of the present disclosure.

FIG. 3A illustrates an exploded view of the embodiment of the system of FIG. 2.

FIG. 3B illustrates an example isolator pad, an example retention plate, and an example fastener of the system of FIG. 2 according to an embodiment of the present disclosure.

FIG. 4 illustrates a table of validation testing results for various embodiments of the system for isolating forces between an air tank and a support rail and a perspective view of an embodiment of a system for isolating forces between an air tank and a support rail.

### DETAILED DESCRIPTION

Air tanks for braking systems on trucks and trailers can have thin walls and often include attachment brackets welded on each end for mounting the air tank on to a suspension frame between the wheels of the truck or trailer. The systems and methods described herein can dampen and/or isolate an air tank from vibrational and impact forces seen in a vehicle suspension frame. By isolating the air tank from the vibrational and impact forces, the welds between the air tank and the attachment bracket can exhibit a much longer life due to lower stresses being transmitted into the welds. This increase in the life of the attachment bracket-to-air tank weld can advantageously reduce the frequency and severity of cracking in the thin-walled air tank, which in turn can reduce the frequency and severity of brake failures due to inadequate air pressure.

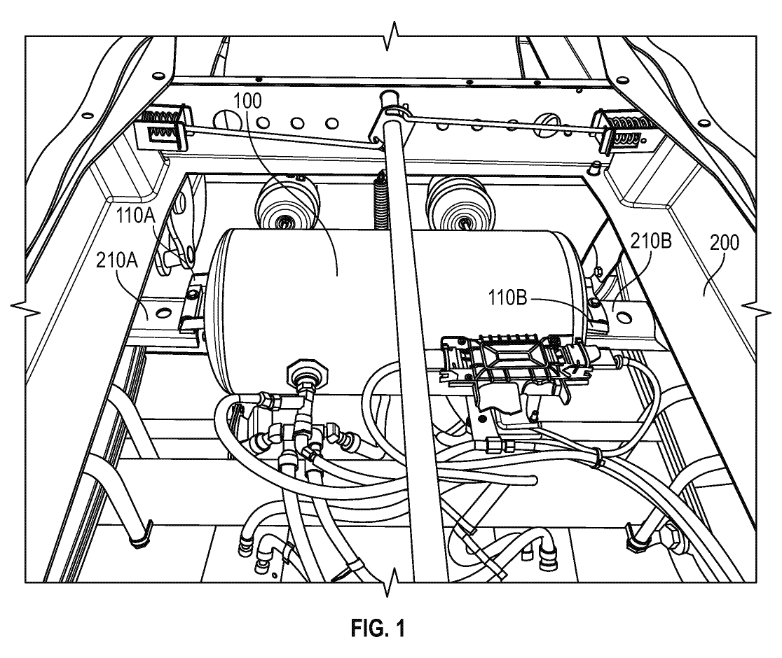

FIG. 1 illustrates a view of an air tank 100 coupled or attached to a suspension frame 200 of a trailer according to an embodiment of the present disclosure. Although embodiments of the present disclosure are described with reference to an air tank coupled or attached to a trailer, it will be understood that systems according to the present disclosure can be suitably implemented on many different kinds of vehicles (for example, recreational and construction vehicles).

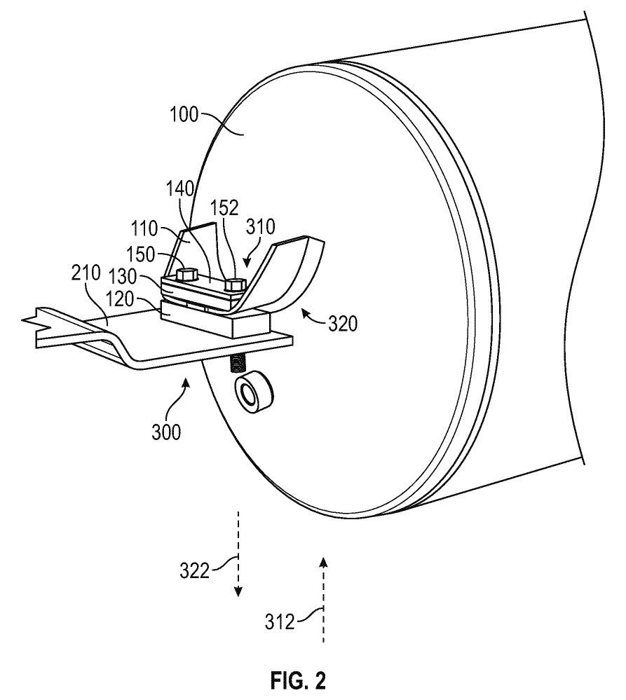

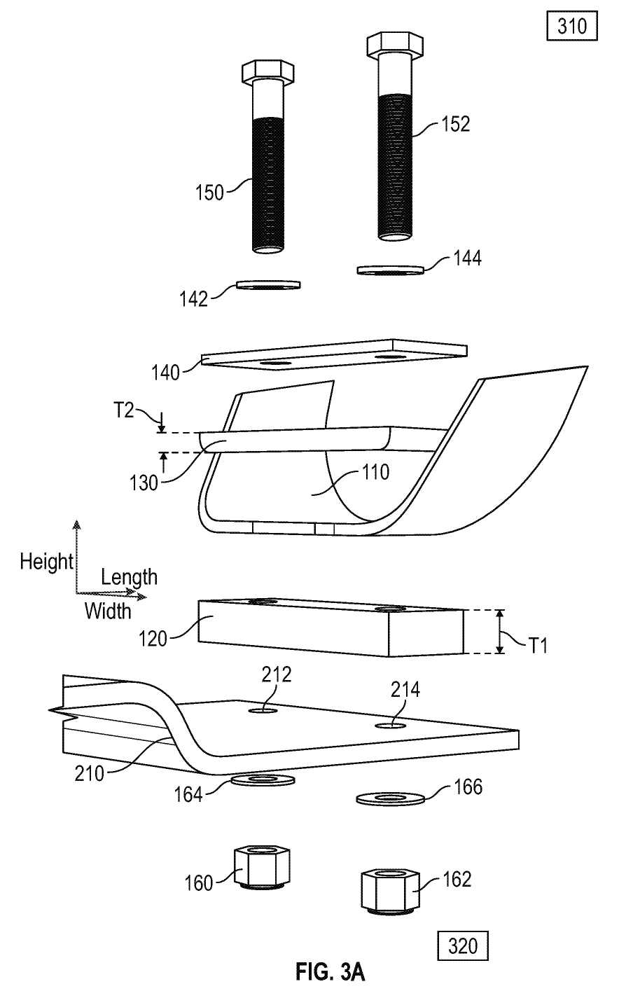

The suspension frame 200 includes a first support rail 210A and a second support rail 210B configured to support the air tank 100. The first support rail 210A and the second support rail 210B can be positioned between a first side (for example, a passenger’s side) of the suspension frame 200 and a second side (for example, a driver’s side) of the suspension frame 200. The air tank 100 in this example is a cylindrical tank. The air tank 100 includes a first attachment bracket 110A which is positioned at a first end of the air tank 100, and a second attachment bracket 110B which is positioned at a second end of the air tank 100. The first attachment bracket 110A and/or the second attachment bracket 110B can be an air tank ear bracket. The first attachment bracket 110A is welded to the first end of the air tank 100 and the second attachment bracket 110B is welded to the second end of the air tank 100. The first attachment bracket 110A attaches to the first support rail 210A and the second attachment bracket 110B attaches to the second support rail 210B. The present disclosure provides systems and methods for dampening and/or isolating forces from the suspension frame 200 into the attachment brackets 110A, 110B of the air tank 100. For example, a system 300, described below with reference to FIGS. 2 and 3, can be implemented at each end of the air tank 100. A first system 300 can attach the first attachment bracket 110A to the first support rail 210A and a second system 300 can attach the second attachment bracket 110B to the second support rail 210B.

FIGS. 2 and 3A illustrate a system 300 for isolating forces between an air tank 100 and a support rail 210 according to an embodiment of the present disclosure. Figure 2 illustrates a perspective view of the system 300 as assembled. FIG. 3A illustrates an exploded view of the system 300. The system 300 is configured to interact with an attachment bracket 110 of an air tank 100. The system 300 can attach or couple the attachment bracket 110 to a support rail 210 of a suspension frame (not illustrated in FIGS. 2 and 3A). The system 300 includes a first fastener 150, a second fastener 152, a retention plate 140, a first isolator pad 120, and a second isolator pad 130.

The attachment bracket 110 includes a top side 310 and a bottom side 320. The attachment bracket 110 is attached to an end of the air tank 100. The support rail 210 is generally disposed below the bottom side 320 of the attachment bracket 110.

The first isolator pad 120 is positioned between the attachment bracket 110 and the support rail 210. The first isolator pad 120 is positioned against the attachment bracket 110 and the support rail 210. In this non-limiting example, the first isolator pad 120 is in direct physical contact with the attachment bracket 110 and the support rail 210, but it will be understood that the system 300 may include other components between the first isolator pad 120 and the attachment bracket 110 and/or between the first isolator pad 120 and the support rail 210.

The second isolator pad 130 is positioned between the attachment bracket 110 and the retention plate 140. The second isolator pad 130 is positioned against the attachment bracket 110 and the retention plate 140. In this non-limiting example, the second isolator pad 130 is in direct physical contact with the attachment bracket 110 and the retention plate 140, but it will be understood that the system 300 may include other components between the second isolator pad 130 and the attachment bracket 110 and/or between the second isolator pad 130 and the retention plate 140.

The first fastener 150 and the second fastener 152 are configured to fasten the retention plate 140, the second isolator pad 130, the attachment bracket 110, the first isolator pad 120, and the support rail 210 together. It will be understood that other numbers and types of fasteners can be suitably implemented. In this non-limiting example, the first fastener 150 and the second fastener 152 pass through the retention plate 140, the second isolator pad 130, the attachment bracket 110, the first isolator pad 120, and the support rail 210. The first fastener 150 and the second fastener 152 are threaded bolts in this example. The head of the first fastener 150 and the head of the second fastener 152 are positioned against the retention plate 140. The head of the first fastener 150 and the head of the second fastener 152 can be in direct physical contact with the retention plate 140, but other configurations can be suitably implemented. A first washer 142 can optionally be positioned between the head of the first fastener 150 and the retention plate 140. A second washer 144 can optionally be positioned between the second fastener 152 and the retention plate 140. The first fastener 150 and the second fastener 152 can be configured to fasten the retention plate 140, the second isolator pad 130, the attachment bracket 110, the first isolator pad 120, and the support rail 210 together using a first nut 160 and a second nut 162, threaded on the first fastener 150 and the second fastener, respectively. A first washer 164 can be positioned between the first nut 160 and the support rail 210. A second washer 166 can be positioned between the second nut 162 and the support rail 210. The first nut 160 can engage with the first fastener 150. The second nut 162 can engage with the second fastener 152.

The first isolator pad 120 and the second isolator pad 130 can be formed of resilient material. The first isolator pad 120 and the second isolator pad 130 can be configured to dampen and/or distribute forces (for example, vibrational forces or impact forces) from the support rail 210. The first isolator pad 120 and the second isolator pad 130 can reduce or prevent forces from the support rail from being transferred into the attachment bracket 110, thereby isolating or partially isolating the air tank 100 from forces generated in the suspension frame 200. The first isolator pad 120 can dampen and/or distribute forces generally extending in a first direction 312 (for example, forces generally extending towards the top side 310) from passing from the support rail 210 into the attachment bracket 110. The second isolator pad 130 can dampen and/or distribute forces generally extending in a second direction 322 (for example, forces generally extending towards the bottom side 320) from passing from the support rail 210 into the attachment bracket 110. The first direction 312 can be generally opposite to the second direction 322. The first direction 312 can be generally parallel to the second direction 322. The combination of the first isolator pad 120 and the second isolator pad 130 can dampen and/or distribute forces in the first direction 312, the second direction 322, and rotational forces imparted on the air tank 100 by the support rail 210. For example, some embodiments of the present disclosure can be configured to reduce 4G dynamic loads on the attachment bracket of an air tank by as much as 50%. Advantageously, dampening and/or distributing forces transferred from the support rail 210 into the attachment bracket 110 can reduce the stress and strain in the weld connecting the attachment bracket 110 to the air tank 100. By isolating or partially isolating the air tank 100 from translational and rotation forces imparted by the support rail 210, the fatigue life of the air tank 100 can be greatly improved. Additionally, improving the fatigue life of the air tank 100 can reduce the risk that weakness in or failure of the weld between the attachment bracket 110 and the air tank 100 will cause a leak in the air tank 100, thereby improving the safety of the air tank and associated braking systems.

The first isolator pad 120 and the second isolator pad 130 can dampen and/or distribute forces in combination with other components of the system 300, for example, the retention plate 140. It will be understood, however, that embodiments of the system 300 need not include a retention plate 140.

The first isolator pad 120 and the second isolator pad 130 can be formed of any suitable resilient material. For example, the first isolator pad 120 and the second isolator pad 130 can be formed of natural rubber, styrene-butadiene rubber (SBR), butyl (IIR), Nitrile (NBR), or neoprene. The first isolator pad 120 has a thickness T1 measured in a height direction. The second isolator pad 130 has a thickness T2 measured in the height direction. In some embodiments, the thickness T2 of the second isolator pad 130 is greater than the thickness T1 of the first isolator pad 120. In some embodiments, the thickness T1 of the first isolator pad 120 is greater than the thickness T2 of the second isolator pad 130. In some embodiments, the thickness T1 of the first isolator pad 120 is twice the thickness T2 of the second isolator pad 130. In some embodiments, the first isolator pad 120 has a thickness T1 measured in the height direction of about 1/8”, 3/16”, 1/4”, 5/16”, 3/8”, 1/2”, 9/16”, 5/8”, 11/16”, 3/4”, 13/16”, 7/8”, 15/16”, or 1”. In some embodiments, the thickness T2 of the second isolator pad 130 is the same as the thickness T1 of the first isolator pad 120. In some embodiments, the thickness T2 of the second isolator pad 130 is half the thickness T1 of the first isolator pad 120. In some embodiments, the second isolator pad 130 has a thickness T2 in the height direction of about 1/8”, 3/16”, 1/4”, 5/16”, 3/8”, 1/2”, 9/16”, 5/8”, 11/16”, 3/4”, 13/16”, 7/8”, 15/16”, or 1”. In some embodiments of the present disclosure, the first isolator pad 120 has a thickness T1 measured in a height direction of 1/2” inch, and the second isolator pad 130 has a thickness T2 of 1/4”.

In some embodiments, the first isolator pad 120 can have a width in a width direction of about 2”, 2.5”, 2.6”, 2.7”, 2.8”, 2.9”, 3”, 3.1”, 3.2”, 3.3”, 3.4”, 3.5”, 3.6”, 3.7”, 3.8”, 3.9”, 4”, or 4.5”. In some embodiments, the first isolator pad 120 can have a length in a length direction of about 0.5”, 0.6”, 0.7”, 0.75”, 0.8”, 0.9”, 1”, 1.1”, 1.2”, 1.25”, 1.3”, 1.4”, 1.5”, 1.6”, 1.7”, 1.75”, 1.8”, 1.9”, or 2”. In some embodiments, the first isolator pad 120 can have a thickness T1 of about 1/2”, a width of about 3.4”, and a length of about 1.25”. In some embodiments, the second isolator pad 130 can have a width in a width direction of about 2”, 2.5”, 2.6”, 2.7”, 2.8”, 2.9”, 3”, 3.1”, 3.2”, 3.3”, 3.4”, 3.5”, 3.6”, 3.7”, 3.8”, 3.9”, 4”, or 4.5”. In some embodiments, the second isolator pad 130 can have a length in a length direction of about 0.5”, 0.6”, 0.7”, 0.75”, 0.8”, 0.9”, 1”, 1.1”, 1.2”, 1.25”, 1.3”, 1.4”, 1.5”, 1.6”, 1.7”, 1.75”, 1.8”, 1.9”, or 2”. In some embodiments, the second isolator pad 130 can have a thickness T2 of about 1/4”, a width of about 3.4”, and a length of about 1.25”. In some embodiments, the retention plate 140 can have a width in a width direction of about 2”, 2.5”, 2.6”, 2.7”, 2.8”, 2.9”, 3”, 3.1”, 3.2”, 3.3”, 3.4”, 3.5”, 3.6”, 3.7”, 3.8”, 3.9”, 4”, or 4.5”. In some embodiments, the retention plate 140 can have a length in a length direction of about 0.5”, 0.6”, 0.7”, 0.75”, 0.8”, 0.9”, 1”, 1.1”, 1.2”, 1.25”, 1.3”, 1.4”, 1.5”, 1.6”, 1.7”, 1.75”, 1.8”, 1.9”, or 2”. In some embodiments, the retention plate 140 can have a thickness in the height direction of about 0.05”, 0.1”, 0.11”, 0.12”, 0.13”, 0.14”, 0.15”, or 0.2”. In some embodiments, the first isolator pad 120 can have a thickness of about 0.13”, a width of about 3.4”, and a length of about 1.25”.

In some embodiments, the retention plate 140 distributes the compressive force of the first fastener 150 and the second fastener 152 across the surface area of the top surface of second isolator pad 130. In some embodiments, a first retention plate is positioned under the head of the first fastener 150 and a second retention plate is positioned under the head of the second fastener 152.

In some embodiments, the nut 160 and/or the nut 162 can be a locking nut. In some embodiments, the nut 160 and/or the nut 162 can include a nylon locking insert. In some embodiments, the first fastener 150 is torqued to about 18 lb-ft. In some embodiments, the second fastener 152 is torqued to about 18 lb-ft. In some embodiments, the first fastener 150 is torqued to about 16 lb-ft, 17 lb-ft, 18 lb-ft, 19 lb-ft, 20 lb-ft, 21 lb-ft, 22 lb-ft, 23 lb-ft, 24 lb-ft, or any other suitable torque. In some embodiments, the second fastener 152 is torqued to about 16 lb-ft, 17 lb-ft, 18 lb-ft, 19 lb-ft, 20 lb-ft, 21 lb-ft, 22 lb-ft, 23 lb-ft, 24 lb-ft, or any other suitable torque.

Systems according to embodiments of the present disclosure can be assembled via a method of assembling an air tank 100 on a suspension frame 200 including two support rails 210. The method can include positioning a first resilient isolator pad 120 on top of a support rail 210 of the suspension frame 200. The method can further include positioning the air tank 100 relative to the support rail 210. The air tank 100 can include a pair of air tank attachment brackets 110. Positioning the air tank 100 can include positioning an attachment bracket 110 of the pair of attachment brackets 110 over the first resilient isolator pad 120 such that the first resilient isolator pad 120 is between the support rail 210 and a first side of the attachment bracket 110. The method can further include positioning a second isolator pad 130 and a retention plate 140 on a second side of the attachment bracket 110 opposite the first side. The method can further include passing one or more fasteners 150 through the retention plate 140, the second isolator pad 130, the first isolator pad 120, and the support rail 210. The method can further include fastening each of the one or more fasteners 150 to a torque. The method can repeated for a second attachment bracket 110 of the pair of attachment brackets 110 of the air tank 100. For example, the second attachment bracket 110 can be assembled on a second support rail 210 of the suspension frame 200 in accordance with an embodiment of the above-described method of the present disclosure.

In another non-limiting embodiment of the present disclosure, a method can be provided to install a system 300 to isolate forces between an air tank attachment bracket 110 of an air tank 100 and a support rail 210 of a suspension frame 200. The method can include inserting a first resilient isolator pad 120 between the attachment bracket 110 and the suspension rail 210 of a suspension frame 200. The method can include aligning the holes of the first resilient isolator pad 120 with the holes of the attachment bracket 110 and the holes of the suspension rail 210. The method can include pre-assembling a retention plate 140, a second resilient isolator pad 130, and two fasteners 150 and 152 together to form a top kit. The pre-assembling can include stacking the retention plate 140 on top of the second resilient isolator pad 130, aligning the holes, and passing each of the fasteners 150 and 152 through the retention plate 140 and the second resilient isolator pad 130 to form the top kit. The retention plate 140 can include a pair of notched corners. The second resilient isolator pad 130 can include a pair of notched corners. The notched corners of the retention plate 140 can align with the notched corners of the second resilient isolator pad 130. The notched corners can advantageously aid in aligning the retention plate 140 with the second resilient isolator pad 130. The method can include inserting the top kit by aligning the two fasteners 150 and 152 with the holes in the attachment bracket 110, and passing the fasteners 150 and 152 through the attachment bracket 110, the first resilient isolator pad 120, and the suspension rail 210. The notched corners of the retention plate 140 and the second resilient isolator pad 130 can advantageously aid in the fitment between the attachment bracket 110 and the top kit by increasing and/or creating clearance between the top kit and the attachment bracket 110. The method can further include using a wrench to hold the head of the fastener 150, inserting a washer 164 and a nut 160 onto the fastener 150, and tightening the nut 160 via an impact gun. This step of the method can be repeated for the second fastener 152. The method can include torquing the nuts. The nuts can be torqued in sequence. For example, the first fastener can be torqued first, the second fastener can be torqued second, the first fastener can be torqued a second time and the second fastener can be torqued a second time. The torque can be between 10 lb-ft and 20 lb-ft, for example, 14 lb-ft to 16 lb-ft, for example 15 lb-ft. These steps can be repeated to install a system 300 to isolate forces between a second air tank attachment bracket 110 of the air tank 100 and a second support rail 210 of the suspension frame 200.

FIG. 3B illustrates an example second resilient isolator pad 130, an example retention plate 140, and an example fastener 150 of the system 300 according to an embodiment of the present disclosure. The second resilient isolator pad 140, the retention plate 140, and the fastener 150 can be pre-assembled to form a top kit as described above. The second isolator pad 130 can have notched corners as illustrated in FIG. 3B. The retention 140 plate can have notched corners as illustrated in FIG. 3B. The notched corners can advantageously increase the clearance between an attachment bracket 110 of an air tank 100 and the top kit when the top kit is installed on the attachment bracket 110. The notched corners can reduce or mitigate any stress risers that may occur due to the corners of the second isolator pad and/or the retention plate contacting raised or curved portions of the attachment bracket 110.

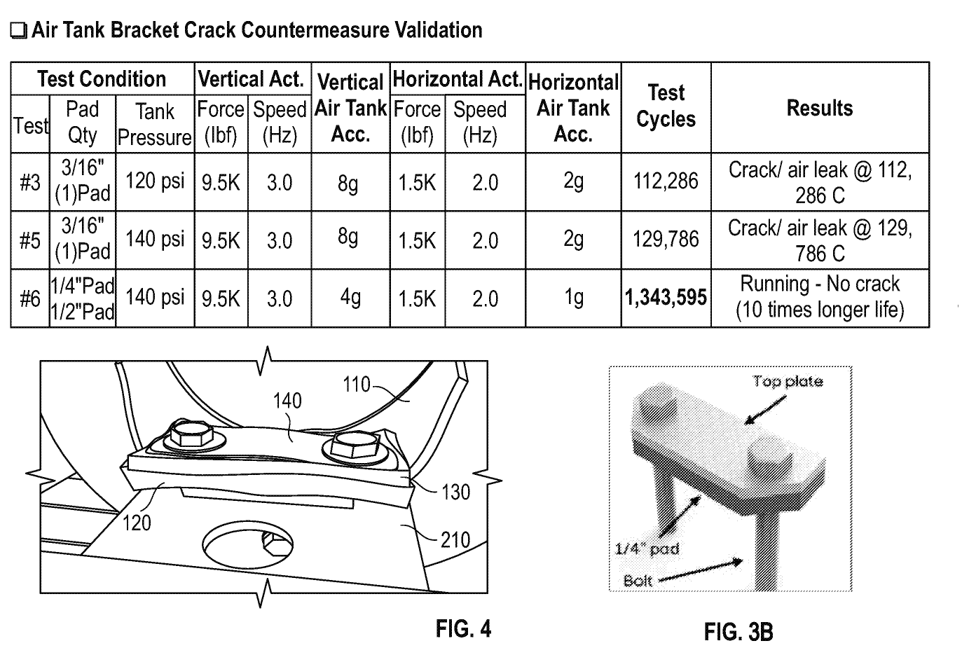

FIG. 4 illustrates a table of validation testing results for an embodiment of a system 300 according to an embodiment of the present disclosure for isolating forces between an air tank attachment bracket 110 of an air tank 100 and a support rail 210 of a suspension frame 200. FIG. 4 also illustrates a perspective view of the system 300 that was used for validation testing. The system 300 included a first isolator pad 120 having a thickness T1 measured in a height direction of 1/2”, and a second isolator pad 130 having a thickness T2 of 1/4”. A perspective view of an embodiment the system 300 under test is illustrated in FIGURE4, where the first isolator pad 120 is positioned above the attachment bracket 110 and the second isolator pad 130 is positioned between the attachment bracket 110 and the support rail 210. The system 300 was tested with an air tank having 140 psi pressure. Results of validation testing for the system 300 are provided in Test #6.

A system including a single isolator pad having a thickness T1 measured in a height direction of 3/16” positioned between an air tank attachment bracket 110 and a support rail 210 was also tested. In Test #3, the system including only a single isolator pad was tested with an air tank having 120 psi pressure. In Test #5, the system including only a single isolator pad was tested with an air tank having 140 psi pressure. In Test #3 and Test #5, the systems including only a single isolator pad exhibited air tank failure, including cracking of the air tank 100 and leaking of air from the air tank 100, at significantly fewer cycles (for example, 112286 and 129786 cycles respectively) than in Test #6. Advantageously, as evidenced by the validation testing results for Test #6, the system 300 (which included a first isolator pad having a thickness T1 of 1/2” positioned below the attachment bracket and a second isolator pad having a thickness T2 of 1/4” positioned above the attachment bracket) did not exhibit any air tank failure even at substantially higher cycles (for example, 1,343,595 cycles).

Accordingly, systems for isolating forces between an attachment bracket 110 of an air tank 100 and a support rail 210 of a suspension frame 200A according to embodiments of the present disclosure exhibited at least a ten (10) times longer service life with no cracking of the air tank or air leaks compared to systems including only a single isolator pad. In addition, vertical air tank acceleration (4g) and horizontal air tank acceleration (2g) experienced by the air tank 100 in Test #6 using the system 300 was half the vertical acceleration (8g) and horizontal acceleration (2g) experienced by the air tanks 100 in Test #3 and Test #5. The validation testing summarized in FIG. 4 illustrates that embodiments of the systems 300 according to the present disclosure dramatically increase the life of the attachment bracket-to-air tank weld, (at least a ten (10) improvement in life span), can advantageously reduce the frequency and severity of cracking and leaks in an air tank, and can reduce the frequency and severity of brake failures due to inadequate air pressure caused by cracked and leaking air tanks.

The above-described embodiments have been provided by way of example, and the present disclosure is not limited to these examples. Multiple variations and modifications to the disclosed embodiments will occur, to the extent not mutually exclusive, to those skilled in the art upon consideration of the foregoing description. Additionally, other combinations, omissions, substitutions and modifications will be apparent to the skilled artisan in view of the disclosure herein. Accordingly, the present disclosure is not intended to be limited by the disclosed embodiments.

Any feature or combination of features described herein are included within the scope of the present disclosure provided that the features included in any such combination are not mutually inconsistent as will be apparent from the context, this description, and the knowledge of one skilled in the art. In addition, any feature or combination of features may be specifically excluded from any embodiment of the present disclosure. For purposes of summarizing the present disclosure, certain aspects, advantages, and novel features of the present disclosure are described herein. Of course, not necessarily all such aspects, advantages, or features will be present in any particular embodiment of the present disclosure.

Further, various embodiments disclosed herein are to be taken in the illustrative and explanatory sense and should in no way be construed as limiting of the present disclosure. All joinder references (for example, connected, associated, coupled, and the like) are only used to aid the reader’s understanding of the present disclosure, and may not create limitations, particularly as to the position, orientation, or use of the elements disclosed herein. Therefore, joinder references, if any, are to be construed broadly. Moreover, such joinder references may not necessarily infer that two elements are directly connected to each other.

It will also be appreciated that one or more of the elements depicted in the drawings/figures can also be implemented in a more separated or integrated manner, or even removed in certain cases, as is useful in accordance with a particular application.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The ranges disclosed herein also encompass any and all overlap, sub-ranges, and combinations thereof.

Conditional language used herein, such as, among others, “can,” “might,” “may,” “for example,” and the like, unless specifically stated otherwise, or otherwise understood within the context as used, is generally intended to convey that some embodiments include, while other embodiments do not include, certain features, elements, and/or states. Thus, such conditional language is not generally intended to imply that features and/or elements are in any way required for one or more embodiments.

Additionally, all numerical terms, such as, but not limited to, “first”, “second”, “one”, “another”, or any other ordinary and/or numerical terms, should also be taken only as identifiers, to assist the reader’s understanding of the various elements, embodiments, variations and/ or modifications of the present disclosure, and may not create any limitations, particularly as to the order, or preference, of any element, embodiment, variation and/or modification relative to, or over, another element, embodiment, variation and/or modification.

What is claimed is:

1. A system for dampening forces between a suspension frame and an air tank, the system comprising:
a first resilient isolator pad positioned between a first side of an attachment bracket of the air tank and a support rail of the suspension frame;
a second resilient isolator pad positioned on a second side of the attachment bracket;
a retention plate positioned on a side of the second resilient isolator pad opposite the attachment bracket; and
one or more fasteners extending through the retention plate, the second resilient isolator pad, the first resilient isolator pad, and the support rail.

2. The system of claim 1, wherein the first side of the attachment bracket is a bottom side of the attachment bracket.

3. The system of claim 1, wherein the second side of the attachment bracket is a top side of the attachment bracket.

4. The system of claim 1, wherein the retention plate is positioned on a top side of the second resilient isolator pad.

5. The system of claim 1, wherein the retention plate is in direct physical contact with the side of the second resilient isolator pad.

6. The system of claim 1, wherein the first resilient isolator pad is in direct physical contact with the first side of the attachment bracket.

7. The system of claim 1, wherein the first resilient isolator pad is in direct physical contact with the support rail.

8. The system of claim 1, wherein the second resilient isolator pad is in direct physical contact with the second side of the attachment bracket.

9. The system of claim 1, wherein the one or more fasteners comprise one or more threaded bolts engaged with one or more lock nuts.

10. The system of claim 9, wherein a head of each of the one or more threaded bolts is in direct physical contact with the retention plate.

11. The system of claim 1, wherein the first resilient isolator pad has a thickness T1 in a height direction that is greater than a thickness T2 of the second resilient isolator pad.

12. The system of claim 11, wherein the first resilient isolator pad has a thickness T1 of 1/2" and the second resilient isolator pad has a thickness T2 of 1/4".

13. The system of claim 1, wherein the first resilient isolator pad has a thickness T1 in the height direction that is twice a thickness T2 of the second resilient isolator pad.

14. The system of claim 1, wherein at least one of the first resilient isolator pad and the second resilient isolator pad comprise neoprene.

15. A method of assembling an air tank on a suspension frame, the method comprising:
positioning a first resilient isolator pad on top of a support rail of the suspension frame;
positioning the air tank comprising an attachment bracket over the first resilient isolator pad such that the first resilient isolator pad is between the support rail and a first side of the attachment bracket;
positioning a second resilient isolator pad and a retention plate on a second side of the attachment bracket;
passing one or more fasteners through the retention plate, the second resilient isolator pad, the first resilient isolator pad, and the support rail; and
fastening each of the one or more fasteners to a torque.

16. The method of claim 15, further comprising:
positioning a third resilient isolator pad on top of a second support rail of the suspension frame;
positioning a second attachment bracket of the air tank over the third resilient isolator pad such that the third resilient isolator pad is between the second support rail and a first side of the second attachment bracket;
positioning a fourth resilient isolator pad and a second retention plate on a second side of the second attachment bracket;
passing one or more fasteners through the second retention plate, the fourth resilient isolator pad, the third resilient isolator pad, and the second support rail; and
fastening each of the one or more fasteners to a torque.

17. The method of claim 15, wherein the retention plate is in direct physical contact with the second resilient isolator pad.

18. The method of claim 15, wherein the torque comprises between 14-16. lb-ft.

19. The method of claim 15, wherein a thickness T1 of the first resilient isolator pad in a height direction is twice a thickness T2 of the second resilient isolator pad.

20. The method of claim 15, wherein the one or more fasteners comprise one or more threaded bolts, and wherein a head of each of the one or more threaded bolts is in direct physical contact with the retention plate.
